(19) United States
(12) Patent Application Publication
(10) Pub. No.: US 2005/0143110 A1
(43) Pub. Date: Jun. 30, 2005

(54) Method, apparatus and system for managing wireless network channel width capabilities

(76) Inventor: Adrian P. Stephens, Cambridge (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,980

(22) Filed: Dec. 30, 2003

(51) Int. Cl. H04B 7/00; H04Q 7/20

(52) U.S. Cl. 455/509; 455/452.1; 455/452.2

(57) ABSTRACT

A method, apparatus and system for managing wireless network channel width capabilities are generally presented. In this regard, a manager agent is introduced to determine if there is a better channel available for use in response to an indication associated with an arrival of a co-channel wireless network.

### RELATED APPLICATION

This Patent application is related to U.S. patent application Ser. No. 10/______ (attorney docket 042390.P17434) filed Aug. 8, 2003 and entitled “METHOD AND APPARATUS TO SELECT A CHANNEL USING PERFORMANCE METRICS,” assigned to the assignee of the present invention and herein incorporated by reference.

### FIELD OF THE INVENTION

Embodiments of the present invention generally relate to the field of wireless networking, and, more particularly to a method, apparatus and system for managing wireless network channel width capabilities.

### BACKGROUND OF THE INVENTION

With an increasing number of wireless network standards and devices there is a greater need to utilize and share channels efficiently and fairly.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example network environment suitable for implementing the manager agent, in accordance with one example embodiment of the invention;

FIG. 2 is a block diagram of an example manager agent architecture, in accordance with one example embodiment of the invention;

FIG. 3 is a flow chart of an example method for managing wireless network channel width capabilities, in accordance with one example embodiment of the invention; and

FIG. 4 is a block diagram of an example article of manufacture including content which, when accessed by a device, causes the device to implement one or more aspects of one or more embodiment(s) of the invention.

### DETAILED DESCRIPTION

Embodiments of the present invention are generally directed to a method, apparatus and system for managing wireless network channel width capabilities. In this regard, in accordance with but one example implementation of the broader teachings of the present invention, a manager agent is introduced. In accordance with but one example embodiment, the manager agent employs an innovative method to respond to the arrival of a co-channel network by making changes to the channel and/or channel width set used to reduce interference from the arriving co-channel network. According to one example method, the manager agent may select a different channel for operation. According to another example method, the manager agent may restrict its basic channel width set, as described hereinafter.

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

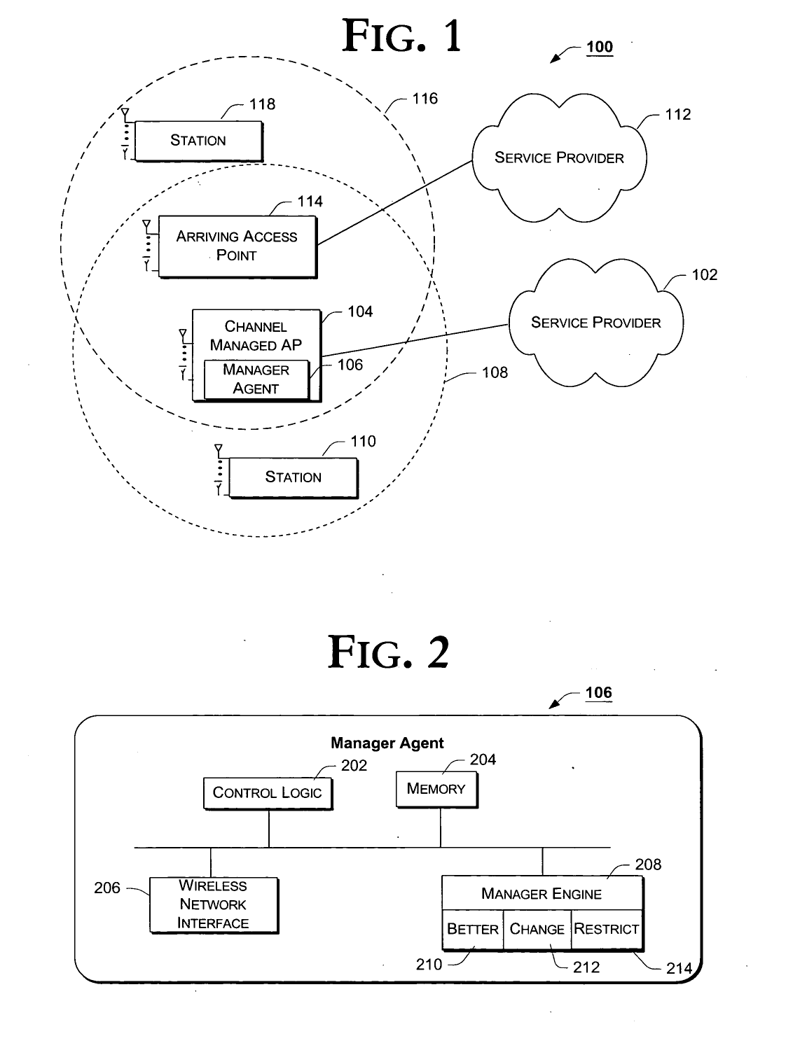

FIG. 1 is a block diagram of an example network environment suitable for implementing the manager agent, in accordance with one example embodiment of the invention. In accordance with the illustrated example embodiment, network environment 100 may include one or more of a service providers 102 and 112, channel managed access point 104, manager agent 106, network areas 108 and 116, stations 110 and 118, and arriving access point 114 coupled as shown in FIG. 1. Manager agent 106, as described more fully hereinafter, may well be used in electronic appliances and network environments of greater or lesser complexity than that depicted in FIG. 1. Also, the innovative attributes of manager agent 106 as described more fully hereinafter may well be embodied in any combination of hardware and software.

Service providers 102 and 112 may represent any medium and/or protocol to communicatively couple electronic devices. In one embodiment, service providers 102 and 112 may represent cable modem or digital subscriber line (DSL) service(s) providing internet access to a residence(s), although the invention is not limited in this regard. In another embodiment, service providers 102 and 112 may represent a local area network (LAN) in a corporate or other setting.

Channel managed access point 104 may represent any type of electronic appliance or device that hosts manager agent 106. In one embodiment, though the present invention is not so limited, channel managed access point 104 may represent a The Institute of Electrical and Electronics Engineers, Inc. (IEEE) 802.11n (amendment to 802.11 standard under development) compliant wireless access point, although the invention is not limited in this regard. Channel managed access point 104 may provide suitably configured electronic appliances within a coverage area (e.g., station 110) with access to service provider 102. In one embodiment, to operate in varying widths of available spectrum, channel managed access point 104 may maintain a channel width set, as explained more fully hereinafter. Generally, a channel width set may represent a set of frequency widths (e.g., 20 MHz, 40 MHz, 60 MHz, 100 MHz, etc.) that are supported by channel managed access point 104 and its associated stations (e.g., station 110). The channel width set may be communicated through a beacon and may be changed at times depending upon the channel width support of associated stations and the availability of spectrum. In one embodiment, a channel width set may be a set of widths that must be supported by a device trying to associate with the network. In another embodiment, a channel width set may be a set of widths that may be used by devices in the network.

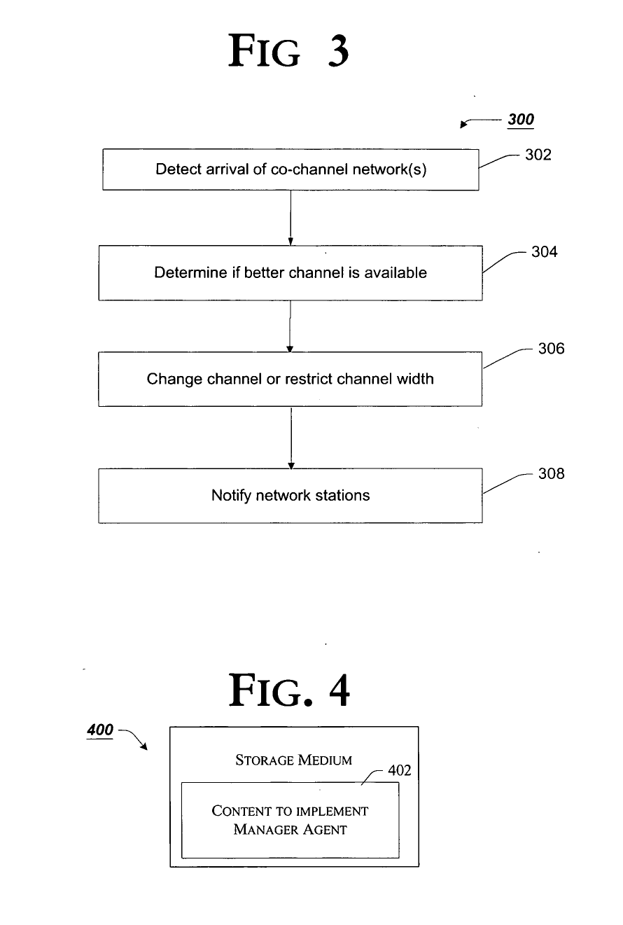

Manager agent 106 may have an architecture as described in greater detail with reference to FIG. 2. Manager agent 106 may also perform one or more methods for managing wireless network channel width capabilities, such as the method described in greater detail with reference to FIG. 3.

Network areas 108 and 116 may represent the maximum signal ranges for channel managed access point 104 and arriving access point 114, respectively. Though depicted as two-dimensional circles for illustration purposes, network areas 108 and 116 may be three-dimensional and may be any shape based on obstructions, terrain, and other factors. In one embodiment, though the present invention is not so limited, channel managed access point 104 may be located in a townhouse or apartment, and network area 108 may extend through a wall of the building, into a neighboring townhouse or apartment where arriving access point 114 may be located. Network area 116 may similarly extend through a wall and overlap with network area 108, creating an area of overlap that could result in interference between the communications of channel managed access point 104 and arriving access point 114.

Stations 110 and 118 may represent laptop, desktop, or handheld computing devices or any other computing devices or appliances that can access network resources through a wireless network. As used herein, a wireless network generally represents any network wherein communications do not require the use of wires or cables. Examples of wireless networks include, but are not limited to, wireless local area networks (WLAN), wireless metropolitan area networks (WMAN), wireless wide are networks (WWAN), and wireless personal area networks (WPAN). Stations 108 and 116 may attempt to communicate with, or connect to, an access point from which it has received a broadcast communication. Furthermore, station 110 may have the ability to negotiate for a set of channel widths to be used in association with channel managed access point 104.

Arriving access point 114 may represent any type of electronic appliance or device that has been configured to interface between station(s) and service provider 112. In one embodiment, though the present invention is not so limited, arriving access point 114 may represent a The Institute of Electrical and Electronics Engineers, Inc. (IEEE) 802.11b standard (approved Sep. 16, 1999, supplement to ANSI/IEEE Std 802.11, 1999 Edition) compliant wireless access point, although the invention is not limited in this regard. Arriving access point 114 may provide suitably configured electronic appliances within network area 116 (e.g., station 118) with access to service provider 112. At the same time, arriving access point 114 may interfere with the communications of other electronic appliances within network area 116 (e.g., channel managed AP 104) that attempt to utilize the same wireless network channel.

FIG. 2 is a block diagram of an example manager agent architecture, in accordance with one example embodiment of the invention. As shown, manager agent 106 may include one or more of control logic 202, memory 204, wireless network interface 206, and manager engine 208 coupled as shown in FIG. 2. In accordance with one aspect of the present invention, to be developed more fully below, manager agent 106 may include a manager engine 208 comprising one or more of better services 210, change services 212, and/or restrict services 214. It is to be appreciated that, although depicted as a number of disparate functional blocks, one or more of elements 202-214 may well be combined into one or more multi-functional blocks. Similarly, manager engine 208 may well be practiced with fewer functional blocks, i.e., with only change services 212, without deviating from the spirit and scope of the present invention, and may well be implemented in hardware, software, firmware, or any combination thereof. In this regard, manager agent 106 in general, and manager engine 208 in particular, are merely illustrative of one example implementation of one aspect of the present invention. As used herein, manager agent 106 may well be embodied in hardware, software, firmware and/or any combination thereof.

As introduced above, manager agent 106 may have the ability to respond to the arrival of a co-channel network by making changes to the channel and/or channel width set used to reduce interference from the arriving co-channel network. In one embodiment, manager agent 106 may change the channel used by channel access point 104 if a better channel is available. In another embodiment, manager agent 106 may restrict the channel width set used by channel access point 104.

As used herein control logic 202 provides the logical interface between manager agent 106 and its host channel managed access point 104. In this regard, control logic 202 may manage one or more aspects of manager agent 106 to provide a communication interface from channel managed access point 104 to wireless network communications, e.g., through wireless interface 206 and one or more antenna(e).

According to one aspect of the present invention, though the claims are not so limited, control logic 202 may receive event indications such as, e.g., arrival of a co-channel access point (e.g., arriving access point 114). Upon receiving such an indication, control logic 202 may selectively invoke the resource(s) of manager engine 208. As part of an example method for managing wireless network channel width capabilities, as explained in greater detail with reference to FIG. 3, control logic 202 may selectively invoke better services 210 that may determine if a better channel is available. Control logic 202 also may selectively invoke change services 212 or restrict services 214, as explained in greater detail with reference to FIG. 3, to change the channel used or restrict the channel width set used, respectively, by channel managed access point 104. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may be used to store a channel width set and other information related to the stations associated with channel managed access point 104, for example.

Wireless network interface 206 provides a path through which manager agent 106 can communicate with other network devices, for example station 110. In one embodiment, wireless network interface 206 may represent any of a wide variety of network interfaces and/or controllers known in the art. In another embodiment, wireless network interface 206 may have the ability to transmit and receive over a wide range of channels and channel widths.

As introduced above, manager engine 208 may be selectively invoked by control logic 202 to determine if a better channel is available, to change the channel used, or to restrict the channel width set used. In accordance with the illustrated example implementation of FIG. 2, manager engine 208 is depicted comprising one or more of better services 210, change services 212 and restrict services 214. Although depicted as a number of disparate elements, those skilled in the art will appreciate that one or more elements 210-214 of manager engine 208 may well be combined without deviating from the scope and spirit of the present invention.

Better services 210, as introduced above, may provide manager agent 106 with the ability to determine if there is a better channel available. In one example embodiment, better services 210 may scan for an unused channel. In another example embodiment, better services 210 may employ a method described in the aforementioned patent application entitled “METHOD AND APPARATUS TO SELECT A CHANNEL USING PERFORMANCE METRICS,” assigned to the assignee of the present invention and herein incorporated by reference.

As introduced above, change services 212 may provide manager agent 106 with the ability to change the channel used be channel managed access point 104. In one example embodiment, change services 212 may change the channel used based on the recommendation of better services 210. In another example embodiment, change services 212 may change the channel to a random or a predetermined channel. Change services 212 may also have the ability to notify stations (e.g., station 110) of the change in channel, for example through a beacon.

Restrict services 214, as introduced above, may provide manager agent 106 with the ability to restrict the channel width set used by channel managed access point 104. In one embodiment, restrict services 214 may remove one or more higher channel width(s) from the channel width set. In another example embodiment, restrict services 214 may remove channel width(s) from the channel width set based on the channel and/or channel widths utilized by arriving access point 114. In one example embodiment, restrict services 214 may remove from the channel width set those widths that are not present in a channel width set of arriving access point 114. Restrict services 214 may also have the ability to notify stations (e.g., station 110) of the change in channel width set, for example through a beacon.

FIG. 3 is a flow chart of an example method for managing wireless network channel width capabilities, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 3 begins with manager agent 106 detecting (302) the arrival of a co-channel network(s) (e.g., arriving access point 114). In one example embodiment, wireless network interface 206 may receive a beacon sent by arriving access point 114. In another example embodiment, wireless network interface 206 may receive a request to associate with arriving access point 114.

Next, control logic 202 may selectively invoke better services 210 to determine (304) if a better channel is available for use by channel managed access point 104. In one example embodiment, better services 210 may determine that a different channel that is not unused is still better than the current channel. In another example embodiment, better services 210 may assume that a different channel is better than the current channel.

Control logic 202 may then selectively invoke either change services 212 or restrict services 214 to change the channel used or restrict the channel width set used (306), respectively, by channel managed access point 104, as appropriate. In one example embodiment, change services may be invoked if better services 210 identified a better channel. In another example embodiment, restrict services 214 may be invoked if better services 210 did not identify a better channel. In another example embodiment, neither restrict services 214 nor change services 212 may be invoked if there is no need, for example if arriving access point 114 supports all the widths in the channel width set of channel managed access point 104.

Next, change services 212 or restrict services 214 may notify (308) network stations of a change in channel or channel width set, respectively. In one embodiment, notification may take place through a beacon. In another embodiment, notification may take place through another frame understood by station 110.

FIG. 4 illustrates a block diagram of an example storage medium comprising content which, when accessed, causes an electronic appliance to implement one or more aspects of the manager agent 106 and/or associated method 300. In this regard, storage medium 400 includes content 402 (e.g., instructions, data, or any combination thereof) which, when executed, causes the appliance to implement one or more aspects of manager agent 106, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

1. A method comprising:
determining if there is a better channel available for use in response to an indication associated with an arrival of a co-channel wireless network.

2. The method of claim 1, further comprising:
notifying station(s) to change to a different channel.

3. The method of claim 1, further comprising:
notifying station(s) to restrict a channel width set.

4. The method of claim 3, wherein notifying station(s) to restrict a channel width set comprises:
notifying station(s) to remove widths from a channel width set that are not present in a channel width set of the co-channel wireless network.

5. The method of either claim 2 or claim 3, wherein determining if there is a better channel available for use comprises:
searching for an unused channel.

6. The method of claim 5, wherein notifying station(s) comprises:
transmitting an Institute of Electrical and Electronics Engineers (IEEE) 802.11 compliant beacon.

7. An electronic appliance, comprising:
one or more dipole antenna(e);
one or more wireless network interface(s), coupled with the one or more dipole antenna(e), to communicate with other devices; and
a manager engine coupled with the wireless network interface(s), the manager engine to determine if there is a better channel available to use in response to an indication associated with an arrival of a co-channel wireless network.

8. The electronic appliance of claim 7, wherein the manager engine to determine if there is a better channel available to use comprises:
the manager engine to search for an unused channel.

9. The electronic appliance of claim 8, further comprising:
the manager engine to notify station(s) to change to a different channel.

10. The electronic appliance of claim 8, further comprising:
the manager engine to notify station(s) to restrict a channel width set.

11. A storage medium comprising content which, when executed by an accessing machine, causes the accessing machine to determine if there is a better channel available for use in response to an indication associated with an arrival of a co-channel wireless network.

12. The storage medium of claim 11, wherein the content to determine if there is a better channel available for use comprises content which, when executed by the accessing machine, causes the accessing machine to search for an unused channel.

13. The storage medium of claim 12, further comprising content which, when executed by the accessing machine, causes the accessing machine to notify station(s) to change to a different channel.

14. The storage medium of claim 12, further comprising content which, when executed by the accessing machine, causes the accessing machine to notify station(s) to restrict a channel width set.

15. The storage medium of either claim 13 or claim 14, wherein the content to notify station(s) comprises content which, when executed by the accessing machine, causes the accessing machine to transmit an Institute of Electrical and Electronics Engineers (IEEE) 802.11 compliant beacon.

16. An apparatus, comprising:
one or more dipole antenna(e);
one or more wireless network interface(s), coupled with the dipole antenna(e), to communicate with other devices; and
control logic coupled with the wireless network interface(s), the control logic to determine if there is a better channel available to use in response to an indication associated with an arrival of a co-channel wireless network.

17. The apparatus of claim 16, wherein the control logic to determine if there is a better channel available to use comprises control logic to search for an unused channel.

18. The apparatus of claim 17, further comprising control logic to notify station(s) to change to a different channel.

19. The apparatus of claim 17, further comprising control logic to notify station(s) to restrict a channel width set.

20. The apparatus of either claim 16 or claim 17, wherein the control logic to notify station(s) comprises control logic to transmit an Institute of Electrical and Electronics Engineers (IEEE) 802.11 compliant beacon.
